(19) United States
(12) Patent Application Publication
(10) Pub. No.: US 2025/0122740 A1
(43) Pub. Date: Apr. 17, 2025

(54) WATER SURFACE CLEANING ROBOT

(71) Applicant: Taizhou Dibiao Technology Co., Ltd., Taizhou (CN)

(72) Inventor: Hua WANG, Taizhou (CN)

(73) Assignee: Taizhou Dibiao Technology Co., Ltd., Taizhou (CN)

(21) Appl. No.: 18/521,008

(22) Filed: Nov. 28, 2023

(30) Foreign Application Priority Data
Oct. 13, 2023 (CN) 202311339714.0

(51) Int. Cl. E04H 4/16; C02F 1/40; C02F 103/00; C02F 103/42; E04H 4/12

(52) U.S. Cl. CPC E04H 4/1654; C02F 1/40; E04H 4/1263; C02F 2103/007; C02F 2103/42

(57) ABSTRACT

A water surface cleaning robot includes a machine body provided with a through groove, an accommodating member located at a front end of the through groove and two symmetrically arranged drivers arranged in the through groove, and the two drivers are both fixedly connected with two side walls of the through groove or a groove bottom of the through groove. In the water surface cleaning robot, a flow guide plate is covered below the driver at a rear end of the through groove, the flow guide plate cooperates with the accommodating member and the through groove to form a cavity penetrating through front and back portions, and a rear end of the flow guide plate is connected with the machine body through a partition plate located between the two drivers.

### CROSS-REFERENCE TO RELATED APPLICATIONS

This application claims priority to Chinese Patent Application No. 202311339714.0, filed on Oct. 13, 2023, the content of which is incorporated herein by reference in its entirety.

### TECHNICAL FIELD

The present application belongs to the field of water surface cleaning machines, and particularly relates to a water surface cleaning robot.

### BACKGROUND

With the gradual improvement of modern living standards, people begin to pay attention to the environment, especially a large amount of floating garbage on a water surface, which not only pollutes water quality, but also easily nourishes mosquito-borne diseases. In order to clean the garbage on the water surface to avoid damaging the environment, the garbage is usually collected by manual collection, with low collection efficiency, so that the prior art provides a water surface cleaning device for collecting floating garbage on the water surface, in which, after the garbage on the water surface is collected by the cleaning device, an accommodating member located in the water surface cleaning device is taken out, and the garbage in the accommodating member is poured out, so as to recycle the garbage. However, due to an influence of complex environment of the water surface, the fluctuation of the water surface may cause some floating objects located at a water inlet of the water surface cleaning device to float out, which may affect a water surface cleaning effect.

### SUMMARY

The present application is intended to provide a water surface cleaning robot aiming at the above problems in the prior art, and the technical problem to be solved by the present application is how to improve garbage recycling efficiency.

The object of the present application can be achieved by the following technical solution: a water surface cleaning robot includes a machine body, the machine body is provided with a through groove, an accommodating member located at a front end of the through groove and two symmetrically arranged drivers are arranged in the through groove, and the two drivers are both fixedly connected with two side walls of the through groove or a groove bottom of the through groove, wherein a flow guide plate is covered below the driver at a rear end of the through groove, the flow guide plate cooperates with the accommodating member and the through groove to form a cavity penetrating through front and back portions only, a rear end of the flow guide plate is connected with the machine body through a partition plate located between the two drivers, and the two drivers are respectively located in two flow channels formed by cooperation of the partition plate, the flow guide plate and the groove wall of the through groove.

According to the present application, the through groove with a downward opening is mainly arranged below the machine body, the through groove extends backward from the front end of the machine body to the rear end of the machine body to facilitate water to enter from the front end and be discharged from the rear end, the machine body is driven to move forward by the driver located at the rear end of the through groove to make the garbage enter the accommodating member located at the front end of the through groove from the front end, and cooperates with a roller brush located at the water inlet at the front end of the machine body to guide the garbage floating on the water surface to enter the accommodating member, wherein the flow guide plate is arranged below the driver, the flow guide plate is fixedly connected with the machine body, so as to form the cavity penetrating through front and back portions only, and make the flow guide plate cooperate with the side walls of the through groove and the partition plate to form the flow channel, because water enters from the front end, the water enters the cavity surrounded by the flow guide plate after filtering the garbage through the accommodating member, and under the action of the driver, a discharged volume is reduced due to the existence of the flow channel, so that a flow speed of water discharged by the driver is increased, and a certain negative pressure may be generated in an interior and at the front end of the accommodating member to fix the garbage in the accommodating member, so as to avoid fine garbage from floating out due to an interference of water flow, thus improving the garbage recycling efficiency.

In the water surface cleaning robot above, each driver is provided with an impeller, and the impeller is located in a straight pipe on the flow channel. The impeller is arranged on the driver, the impeller is driven to rotate by the driver to provide power for the forward movement of the machine body, and the impeller is completely arranged in the cavity penetrating through front and back portions only, so as to ensure pressures of the accommodating member and the water inlet end of the machine body, thus improving the garbage recycling efficiency, and the straight pipe is arranged on the flow channel.

In the water surface cleaning robot above, an electric control assembly is arranged between the accommodating member and the driver, and the flow guide plate covers the electric control assembly and the driver. The electric control assembly and the driver are both arranged in the flow guide plate, so as to avoid strip garbage in water from being entangled with the electric control assembly while avoiding the electric control assembly from being in contact with the driver and the bottom portion, thus improving the stability.

In the water surface cleaning robot above, the accommodating member is located at a front end of the machine body, and the accommodating member, the electric control assembly and the driver are sequentially arranged in the through groove from front to back. Water enters from the accommodating member, and is filtered and then discharged from the driver through the electric control assembly.

In the water surface cleaning robot above, the electric control assembly is arranged between the accommodating member and the driver, and spacings exist between the electric control assembly and two side walls of the through groove respectively.

In the water surface cleaning robot above, when the driver drives the machine body to move forward, the side walls of the through groove cooperate with the front end of the accommodating member to form a negative pressure zone. The machine body is driven to move forward by the driver, and under the cooperation with the flow channel, a flow speed of water in the flow channel is increased, so as to form the negative pressure zone.

In the water surface cleaning robot above, the two side walls at the front end of the through groove are symmetrically arranged inclined guide planes, and the negative pressure zone includes a water inlet formed by cooperation of the inclined guide planes and a front end of the accommodating member and an inner cavity of the accommodating member. The inclined guide planes are arranged at the front end of the through groove, so as to increase an area of the water inlet while reducing a resistance during the movement of the machine body, thus further improving collection efficiency.

In the water surface cleaning robot above, the accommodating member is inserted into the through groove from a front end of the machine body), and a pull handle for facilitating taking is arranged at a front end of the accommodating member. The pull handle is arranged at the front end of the accommodating member, which facilitates taking out the accommodating member from the front end.

Compared with the prior art, the present application has the following advantages.

According to the present application, the accommodating member, the electric control assembly and the driver are respectively arranged in the through groove from front to back, and the flow guide plate is covered below the driver and the electric control assembly, so that the flow guide plate and the groove wall of the through groove cooperate to form the cavity penetrating through front and back portions, two symmetrically placed driving plates are separated by the partition plate, and cooperate with the flow guide plate and the through groove to form the flow channel, and the flow speed of water is further increased in the case of ensuring the same flow rate by reducing a water discharge area, so that the front end of the through groove and the accommodating member form the negative pressure zone, an influence of fluctuation of water flow on garbage recycling is reduced, and smaller garbage is avoided from flowing out of the accommodating member, thus improving the garbage collection efficiency.

Two side walls of the front end of the through groove are both provided with the inclined guide plane to cooperate with the accommodating member to form the trapezoidal water inlet, so as to further increase a coverage area of the negative pressure zone while increasing a garbage collection range, thus improving the garbage collection efficiency.

### BRIEF DESCRIPTION OF THE DRAWINGS

FIG. 1 is a schematic diagram of an exploded structure of a water surface cleaning robot.

FIG. 2 is a rear view of the water surface cleaning robot.

FIG. 3 is a cross-sectional view of an A-A part in FIG. 2.

FIG. 4 is a cross-sectional view of a B-B part in FIG. 2.

### DETAILED DESCRIPTION OF THE EMBODIMENTS

The following descriptions are specific embodiments of the present application, and with reference to the drawings, technical solutions of the present application are further described, but the present application is not limited to these embodiments.

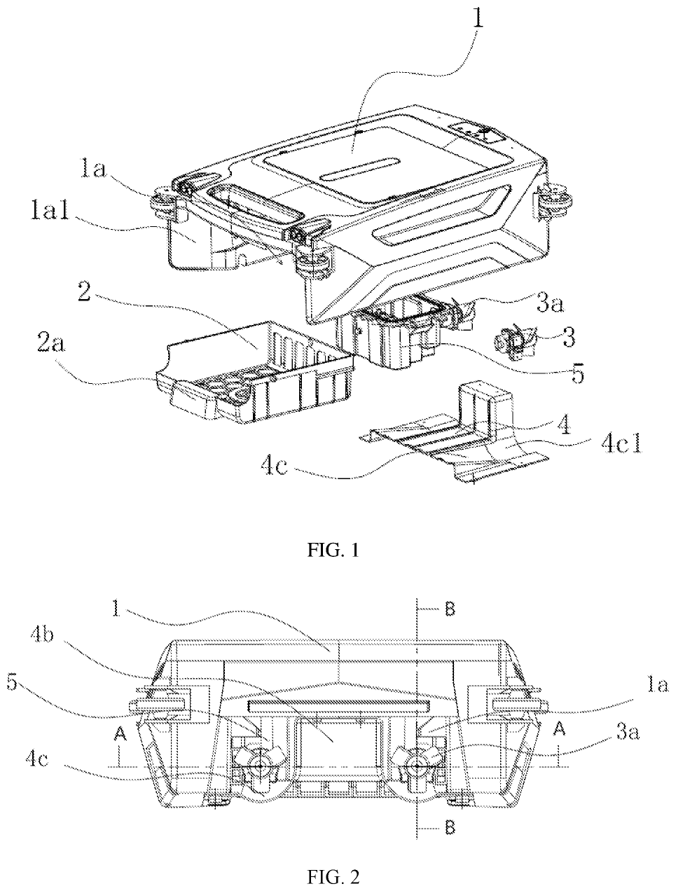

As shown in FIG. 1 and FIG. 2, the present application is a water surface cleaning robot. In a through groove 1a penetrating through front and back portions of the cleaning robot, an accommodating member 2, an electric control assembly 5 and a driver 3 are sequentially arranged in a movement direction of the cleaning robot. Two drivers 3 are provided, two impellers 3a on the drivers 3 are symmetrically arranged backward, a flow guide plate 4a fixed with two sides of the through groove 1a is covered below the electric control assembly 5 and the two drivers 3, and cooperates with a groove wall of the through groove 1a to form a cavity, and a rear end of the flow guide plate 4a is connected with the machine body 1 through a partition plate 4b located between two drivers 3. The partition plate 4b, the groove wall of the through groove 1a and the flow guide plate 4a cooperate to form a flow channel 4c for water discharge, and one section of the flow channel 4c communicated with the outside is provided with a straight pipe 4c1. The driver 3 and the impeller 3a are both located in the flow channel 4c, inclined guide planes are arranged on two side walls of a water inlet portion at a front end of the through groove 1a, and a pull handle 2a is arranged at a front end of the accommodating member 2.

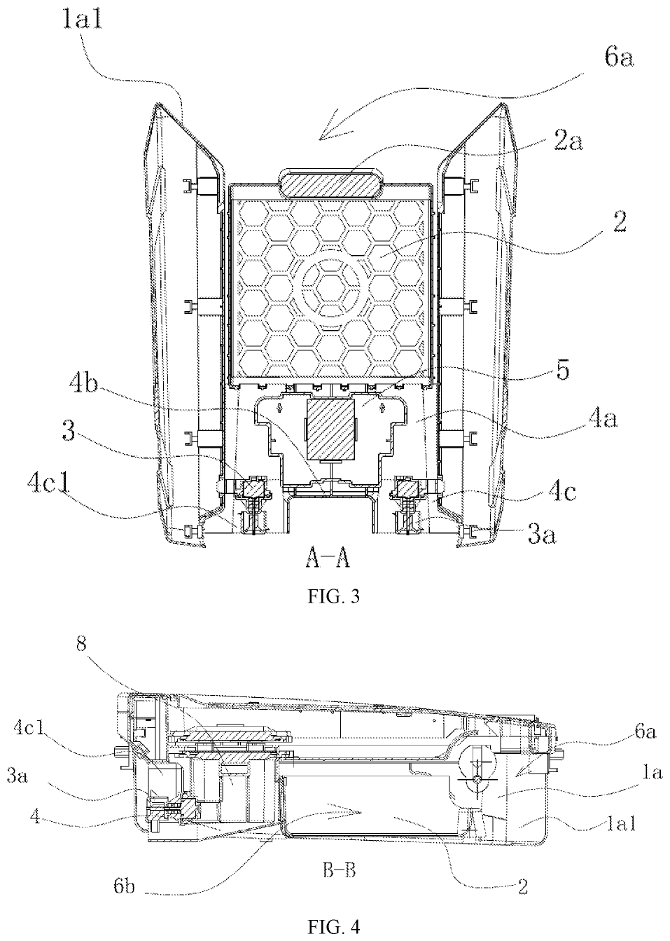

As shown in FIG. 3 and FIG. 4, the accommodating member 2, the electric control assembly 5 and the driver 3 are sequentially arranged from the front end of the through groove 1a in a length direction of the machine body 1, the electric control assembly 5 is located between the accommodating member 2 and the driver 3, and the electric control assembly 5 and the driver 3 are both covered in the cavity formed by the cooperation of the flow guide plate 4a and the through groove 1a. The flow guide plate 4a cooperates with a rear wall of the accommodating member 2, and the flow channel 4c for water discharge is arranged at a rear end of the machine body 1, so as to make the cavity penetrate through front and back portions. The flow channel 4c is provided with the straight pipe 4c1, and the impeller 3a on the driver 3 is located right above the straight pipe 4c1. Two inclined guide planes 1a1 are symmetrically arranged at front ends of two side groove walls of the through groove 1a, and cooperate with the front end of the accommodating member 2 to form a trapezoidal water inlet 6a, and the water inlet 6a and the inner cavity 6b of the accommodating member form a negative pressure zone 6.

A main working principle of the present application is that, when the water surface cleaning robot works in a swimming pool, a pond or a place where garbage on a water surface needs to be treated, the driver 3 leads the impeller 3a to drive the machine body 1 to move forward, the garbage on the water surface is gathered together through the water inlet 6a formed by the cooperation of the inclined guide planes at the front end of the through groove 1a and the accommodating member 2, and a water flow is stirred by a roller brush on the machine body 1, so that the garbage floating on the water surface enters the accommodating member 2, and is filtered by the accommodating member 2 and then discharged into a pool again from the rear wall of the accommodating member 2.

In order to avoid ripples on the water surface from entering the water inlet 6a during running of the water surface cleaning robot and make fine garbage floating on the water surface flow back into the swimming pool from the water inlet 6a, the flow guide plate 4a is covered below the driver 3 for driving the machine body 1 to move and the electric control assembly 5, the front end of the flow guide plate 4a cooperates with the accommodating member 2, and the flow channel 4c for accommodating the driver 3 is arranged at the rear end of the flow guide plate 4a, so that the flow guide plate 4a and the through groove 1a cooperate to form the cavity penetrating through front and back portions, and filtered water enters the cavity from the rear wall of the accommodating member 2 and then is discharged through the flow channel 4c. Because the flow channel 4c is formed by the cooperation of the groove wall of the through groove 1a, the flow guide plate 4a and the partition plate 4b, and the driver 3 is arranged in the flow channel 4c, a water discharge speed is increased by reducing a water discharge area in the case of the same flow rate, so that the inner cavity 6b of the accommodating member 2 and the water inlet 6a of the machine body 1 form the negative pressure zone 6, and fine garbage can be fixed in the accommodating member 2 to avoid escaping into the pool, thus improving garbage recycling efficiency.

The electric control assembly 5 is arranged between the accommodating member 2 and the driver, and arranged together with the driver in the cavity formed by the cooperation of the flow guide plate 4a and the groove wall of the through groove 1a, so that a flow speed of water is increased by further increasing an area of the cavity while simplifying a device and improving a space utilization rate of the device, and then is further increased through the impeller 3a, and smaller floating objects are avoided from entering the pool again by forming the negative pressure zone 6 in the through groove 1a, thus improving the garbage recycling efficiency

On this basis, the drivers 3 are symmetrically arranged with the partition plate 4b as a center, the straight pipe 4cl is arranged at the rear end of the flow channel 4c, and the impeller 3a on the driver 3 is arranged right above the straight pipe 4cl, which is parallel to an axis of the impeller 3a, so as to avoid affecting a posture of the water surface cleaning robot by outward inclination of a water discharge end of the flow channel 4c, thus ensuring normal use of the water surface cleaning device. The inclined guide planes 1a1 are symmetrically placed at the front end of the through groove 1a, and cooperate with the accommodating member 2 to form the water inlet 6a, thus increasing a garbage recycling range of the water surface cleaning device. The pull handle 2a is arranged at the front end of the accommodating member 2, and the accommodating member 2 is taken out from the front end through the pull handle 2a.

The specific embodiments described herein are only illustrative to the spirit of the present application. Those skilled in the technical field to which the present application belongs may make various modifications or supplements to the specific embodiments described or make substitutions in a similar way, without departing from the spirit of the present application or exceeding the scope defined by the appended claims.

The terms of machine body 1, through groove 1a, inclined guide plane 1a1, accommodating member 2, pull handle 2a, driver 3, impeller 3a, flow guide plate 4, cavity 4a, partition plate 4b, flow channel 4c, straight pipe 4cl, electric control assembly 5, negative pressure zone 6, water inlet 6a, inner cavity 6b and the like are frequently used herein, but the possibility of using other terms is not excluded. These terms are only used to describe and explain the essence of the present application more conveniently; and the explanation of the terms as any additional restrictions is against the spirit of the present application.

What is claimed is:

1. A water surface cleaning robot, comprising:
a machine body, the machine body being provided with a through groove;
an accommodating member located at a front end of the through groove; and
two symmetrically arranged drivers arranged in the through groove, and the two drivers being both fixedly connected with two side walls of the through groove or a groove bottom of the through groove, wherein
a flow guide plate is covered below the driver at a rear end of the through groove;
the flow guide plate cooperates with the accommodating member and the through groove to form a cavity penetrating through front and back portions only;
a rear end of the flow guide plate is connected with the machine body through a partition plate located between the two drivers; and
the two drivers are respectively located in two flow channels formed by cooperation of the partition plate, the flow guide plate and the groove wall of the through groove.

2. The water surface cleaning robot according to claim 1, wherein each driver is provided with an impeller, the impeller is located in a straight pipe on the flow channel, and the straight pipe is parallel to an axis of the impeller.

3. The water surface cleaning robot according to claim 2, wherein an electric control assembly is arranged between the accommodating member and the driver, and the flow guide plate covers the electric control assembly and the driver.

4. The water surface cleaning robot according to claim 2, wherein the accommodating member is located at a front end of the machine body, and the accommodating member, the electric control assembly and the driver are sequentially arranged in the through groove from front to back.

5. The water surface cleaning robot according to claim 1, wherein when the driver drives the machine body to move forward, the side walls at the front end of the through groove cooperate to form a negative pressure zone.

6. The water surface cleaning robot according to claim 5, wherein the two side walls at the front end of the through groove are symmetrically arranged inclined guide planes, and the negative pressure zone comprises a water inlet formed by cooperation of the inclined guide planes and a front end of the accommodating member and an inner cavity of the accommodating member.

7. The water surface cleaning robot according to claim 1, wherein the accommodating member is inserted into the through groove from a front end of the machine body, and a pull handle for facilitating taking is arranged at a front end of the accommodating member.
